(19) United States
(12) Patent Application Publication
(10) Pub. No.: US 2008/0251532 A1
(43) Pub. Date: Oct. 16, 2008

(54) BATCH-WISE DISPENSING, FEEDING, AND/OR PACKAGING METHOD, APPARATUS, AND SYSTEM

(75) Inventors: Eliza Westerlaken, Oudenbosch (NL); Catharine Henriette Aarden, Kruisland (NL)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: Somapac, Inc., Londonderry, NH (US)

(21) Appl. No.: 11/735,157

(22) Filed: Apr. 13, 2007

(51) Int. Cl. B67D 5/34

(52) U.S. Cl. 222/1

(57) ABSTRACT

A device, method and system for dispensing of material into a packaging unit is disclosed herein. An exemplary device may have a movable vessel for holding the material prior to dispensing into packing unit. The movable vessel may have walls and a bottom with two or more nozzles extend from the bottom. The nozzles open and close controlling the flow of material from the movable vessel into the packaging unit. The exemplary device may also have a plunger sized to fit within the movable vessel. The plunger provides a seal between a rim of the plunger and the walls of the movable vessel and allows movement in a lateral motion to apply pressure to material within the movable vessel.

### TECHNICAL FIELD

The present invention relates to dispensing, feeding, and/or packaging of materials and more particularly, to dispensing, feeding, and/or packaging of viscous and dense materials.

### BACKGROUND INFORMATION

Pasty materials, suspensions, sealants, cements and adhesives may have one or more of the following properties that make it difficult to dispense, feed and/or package these materials in a batch-wise mode without clogging, contaminating the interior parts of the dispenser, feeder and/or packaging unit. The properties, as mentioned hereinafter, exist in varying combinations, depending on the nature of the material concerned:

The material can be high in viscosity.

The visco-elastic ratio of the material may be dominated by the elastic properties at the shear-rate range exercised to make the material flow-out of the dispensing, feeding and/or packaging unit.

The specific gravity of the material may be relatively high.

The material may be abrasive.

The material may be sensitive to the pressure exercised to make the material flow out of the dispensing, feeding and/or packaging unit.

The material may be shear-rate sensitive at the shear-rate range exercised to make the material flow-out of the dispensing, feeding and/or packaging unit.

The material can be sensitive to degradation and or deterioration caused by the development of micro-organisms as a consequence of contamination of the interior parts of the dispensing, feeding and/or packaging unit.

Present equipment for dispensing, feeding and/or packaging of aforementioned materials may incorporate hydraulic pump feeders equipped with a plunger going down in a cylindrical vessel forcing the material to flow into the hole in the center of the plunger, flowing upwards through a tube/pipe either or not equipped with valves. At the end of the tube/pipe the material then flows into the packaging material. The length of the tube/pipe in relationship to the viscosity and the density of the material may cause difficulty removing the material from the tubes/pipes after finishing a batch. This may cause waste of material and/or potential cross-contamination with material in other batches. The process may also cause undesirable compression of the material. This may cause phase separation and/or cold joint formed agglomerates of metal fillers. End results of the process may provide clogged feeder tubes/pipes and/or build up of the pressure in the tubes/pipes resulting in an explosive breakdown of the tubes/pipes.

The shot size of the pump, which is the result of a preset stroke length of the hydraulic cylinder, has no closed loop control and therefore it is subject to variations in tolerances that quite often are not acceptable for the application.

Another category of present equipment for dispensing, feeding and/or packaging of aforementioned materials may incorporate hydraulic pump feeders equipped with a plunger going down in a cylindrical vessel providing only slight pressure on the material by its own weight. A scooping device takes a defined quantity of the material and pumps it into a hole in the center of the plunger, forcing the material to flow upwards into a tube/pipe either or not equipped with valves. At the end of the tube/pipe the material then flows into the packaging material. Again, the length of the tube/pipe in relationship to the viscosity and the density of the material may cause difficulty removing the material from the tubes/pipes after finishing a batch. This may cause waste of material and/or potential cross-contamination with material in other batches.

The process may also cause undesirable compression of the material. This may cause phase separation and/or cold joint formed agglomerates of metal fillers. End results of the process may provide clogged feeder tubes/pipes and/or build up of the pressure in the tubes/pipes resulting in an explosive breakdown of the tubes/pipes.

Again, the shot size of the pump, which is the result of a preset stroke length of the hydraulic cylinder, also has no closed loop control and therefore it is subject to variations in tolerances that quite often are not acceptable for the application.

Another category of equipment for dispensing, feeding and/or packaging of aforementioned materials may be constructed with multiple nozzle feeders exercising pressure on the product in an enclosed cylindrical vessel, forcing the material to flow upwards into a number of tubes/pipes either or not equipped with valves. At the end of the tube/pipe the material then flows into the packaging material. Again, the length of the tube/pipe in relationship to the viscosity and the density of the material may cause difficulty removing the material from the tubes/pipes after finishing a batch. This may cause waste of material and/or potential cross-contamination with material in other batches. The process may also cause undesirable compression of the material. This may cause phase separation and/or cold joint formed agglomerates of metal fillers. End results of the process may provide clogged feeder tubes/pipes and/or build up of the pressure in the tubes/pipes resulting in an explosive breakdown of the tubes/pipes.

Again, the shot size of the pump, which either is the result of a preset stroke length of the hydraulic cylinder or the pneumatic air pressure, has no closed loop control and therefore is subject to variations in tolerances that quite often are not acceptable for the application.

Another category of equipment for dispensing, feeding and/or packaging of aforementioned materials may incorporate hydraulic presses equipped with a plunger going down in a cylindrical vessel forcing the material to flow into the hole in the center of the bottom of the cylindrical vessel, flowing downward through a tube/pipe. At the end of the pipe a 3-way ball valve is mounted. In its closed position (position 1) some material can enter the outlet tube. In position 2 the material will be pressed into a buffer area. In position 3 (at the end of the cycle) the material will be pressed from buffer area into the packaging material. The pressing of the material, in 2 steps, may cause undesirable results. Again, the length of the tube/pipe in relationship to the viscosity and the density of the material may cause difficulty removing the material from the tubes/pipes after finishing a batch. This may cause waste of material and/or potential cross-contamination with material in other batches. The process may also cause undesirable compression of the material. This may cause phase separation and/or cold joint formed agglomerates of metal fillers. End results of the process may provide clogged feeder tubes/pipes and/or build up of the pressure in the tubes/pipes resulting in an explosive breakdown of the tubes/pipes.

Again, the shot size of the press, which is the result of the length of the tube in the buffer area (position 2), has no closed loop control and therefore it is subject to variations in tolerances that quite often are not acceptable for the application. Accordingly, a need exists for a device, method, and system for improving removal of the material from dispensing equipment and reducing undesirable compression of the material.

### SUMMARY

The present invention is a novel device, system, and method or batch-wise preparing and dispensing of material into a packaging unit. The exemplary method may prepare the material in a movable vessel. The vessel may then be positioned underneath a plunger. The plunger may be moved into the vessel and form a seal between walls of the vessel and a rim of the plunger. Pressure may be applied to the material via the plunger. Packaging units may be positioned underneath two or more nozzles exiting from the vessel. The valve of each nozzle may be opened and material dispensed from the vessel into the packaging unit.

In another exemplary embodiment, the actions of moving the plunger and opening the valves may be controlled by a programmable logic controller. In another exemplary embodiment, successive packaging units may be supplied to each nozzle. In another embodiment, each packaging unit may be weighed after an initial loading and a valve of each nozzle may be opened for a set period of time based on each package weight. In yet another embodiment, each packaged unit may be weighed after an initial loading and a valve of each nozzle opened based on each respective package weight. Embodiments of the invention may have one or more of the following advantages.

The present invention is not intended to be limited to a system or method that must satisfy one or more of any stated objects or features of the invention. It is also important to note that the present invention is not limited to the exemplary or primary embodiments described herein. Modifications and substitutions by one of ordinary skill in the art are considered to be within the scope of the present invention, which is not to be limited except by the following claims.

### BRIEF DESCRIPTION OF THE DRAWINGS

These and other features and advantages of the present invention will be better understood by reading the following detailed description, taken together with the drawings wherein:

FIG. 1 is a side view of a general embodiment of the equipment for dispensing, feeding and/or packaging according to an exemplary embodiment of the present invention.

FIG. 2 is a cross-section of the outlet/nozzle according to an exemplary embodiment with a ball valve setting in the bottom of the cylindrical vessel of the present invention.

FIG. 3 is a cross-section of the outlet/nozzle according to an exemplary embodiment with the flexible tube valve setting in the bottom of the cylindrical vessel of the present invention.

FIG. 4 is a cross-section of the cylindrical vessel positioned in the front/operator side of the general embodiment of the equipment for dispensing, feeding and/or packaging according to an exemplary embodiment of the present invention.

FIG. 5 is a cross-section of the cylindrical vessel positioned in the rear/vessel input side and output side of the general embodiment of the equipment for dispensing, feeding and/or packaging according to an exemplary embodiment of the present invention.

FIG. 6 is a flow chart illustrating an exemplary embodiment for a dispensing, feeding and/or packaging method to be identified and modified according to the present invention.

FIGS. 7A, 7B, and 7C are a cross-section of a vessel being used for preparing and dispensing, feeding and/or packaging according to three different exemplary embodiments of the present invention.

### DETAILED DESCRIPTION

The system may comprise a cylindrical vessel that can be moved into the dispensing, feeding and/or packaging unit on a removable cart or other transport device. The cylindrical vessel includes a bottom with a number of holes in a grid design accommodating the diameter of the cylindrical vessel space needed for the controlling parts as well as evolution in vertical and horizontal pressures caused by the changing level of the column-height of the material.

The system may be used for dispensing, feeding and/or packaging material or material with high density and viscosity. The material may have a specific gravity between about two to eight. The material may have a dynamic viscosity between about fifteen and four hundred Pascal seconds. The system may be used for dispensing, feeding and/or packaging edible, medicinal, cosmetics and industrial products, for example, but not limited to, silicon, condiments, dental paste, solder paste, adhesives, gels, glues, cement paste and dispersions and/or emulsions.

The holes may have a diameter in relationship to the viscosity and the visco-elastic ratio, the grain size and the weight percentage of the non-organic pigments, fillers or metal particles. The inlet of the hole may have a v-shaped design limiting the shear rate accelerations when the material is pressed into the outlet.

In the ball-valve embodiment, the lowest point of the v-shape is the level at the top of the radius of the ball-valve. Every individual hole is opened and closed by a load-cell controlled ball valve. The construction of the bottom enables positioning of the closed ball valve with the top of its radius 3 mm or less under the top-line of the bottom of the cylindrical vessel.

This construction may assure that the cylindrical vessel can be used for blending as well without the risk of building up single component of non-uniform conglomerates of the blend. The construction may also reduce and/or avoid the stress in the material build up by the acceleration of shear-rates when material passes through the holes in the bottom.

The mobile, quickly interchangeable mixing cylindrical vessel is entered into the dispensing, feeding and/or packaging station. A hoof-shaped positioning system, moving upward and downward on two servo motor driven spindles, elevates the cylindrical vessel from the rolling cart upward into the feeding position. Bolts may then secure the cylindrical vessel in the feeding position. When the cylindrical vessel is secured in its feeding position, it may be connected to the Programmable Logic Controller (PLC) or other computer controller through a quick-fit plug-in multiple pin connector and snap-lock air supply.

The plunger may be equipped with a peripheral polymer seal and a valve controlled air inlet/outlet. The air inlet/outlet may be located towards the center of the plunger. When the plunger moves downward in its operating position the air inlet/outlet valve is opened and this device functions as the extractor of any air between the plunger and the material in the vessel. The material may be slightly pressurized by the plunger driven down in a precisely and continuously controlled via a plunger spindle. The plunger spindle may also be driven by a PLC controlled motor. Under minimal and constant pressure the material flows directly through ball valve controlled nozzles into the packaging material. The position of the ball valves at underneath and close to the bottom of the cylindrical vessel may reduce or eliminate any material being pressurized and/or compressed in tubes/pipes. After passing the ball valve, the material flows into the packaging material, for example, jars, cassettes or other packaging without pressure and/or under reduced pressure to move a plunger downwards in a cartridge.

The outlet design for feeding the material into the packaging units without any feeding tubes and/or pipes allows for quick and thorough cleaning without loss of material or cross contamination between batches. In a flexible tube-valve embodiment, the ball valve may be replaced by a flexible silicon tube-valve enabling instant replacement of the tubes at set intervals or between batches. This specific embodiment enables certification for sanitary fitness for pharmaceutical and food applications or other applications require stricter sanitary conditions. The invention is not limited to a ball-valve or tube-valve; other types of valves may also be used.

Packaging units may be inserted into an instantly interchangeable tooling device mounted on a slide-in table or other transport device, for example, a conveyor belt or mobile cart. A packaging unit is situated under each load-cell. The load-cells are connected to a controller that controls open/close position of the nozzle valves in the bottom of the cylindrical vessel. The use of instantly interchangeable tooling devices or inserts positioned over the load-cells allows for changeover to different types of packaging without down-time of the feeding equipment. The system facilitates calibration of the load-cells with certified externally calibrated reference weights.

In the ball-valve embodiment, the system facilitates the filling of cartridges, caulking guns and similar types of packaging, featuring a plunger. When filling these packages through the snout, requiring the plunger to be moved by the inflowing material, a preset counter-pressure can be programmed. This preset pressure automatically is compensated by the controller or computer.

When the cylindrical vessel is empty the valve on the air/inlet/outlet is opened and the plunger can be moved upwards into its parking position. This construction reduces and/or eliminates many drawbacks of the present state of the art feeding systems as be understood from embodiments described herein.

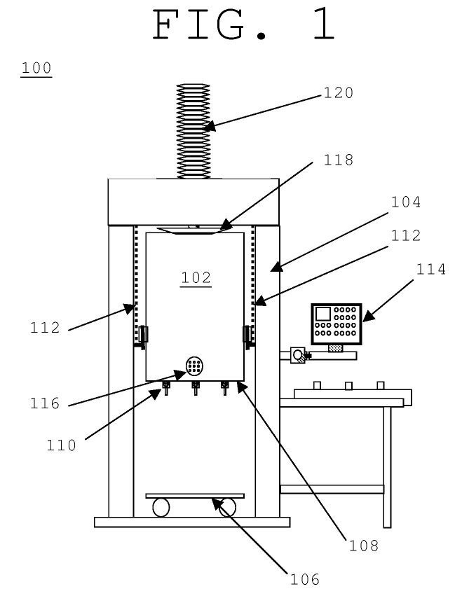

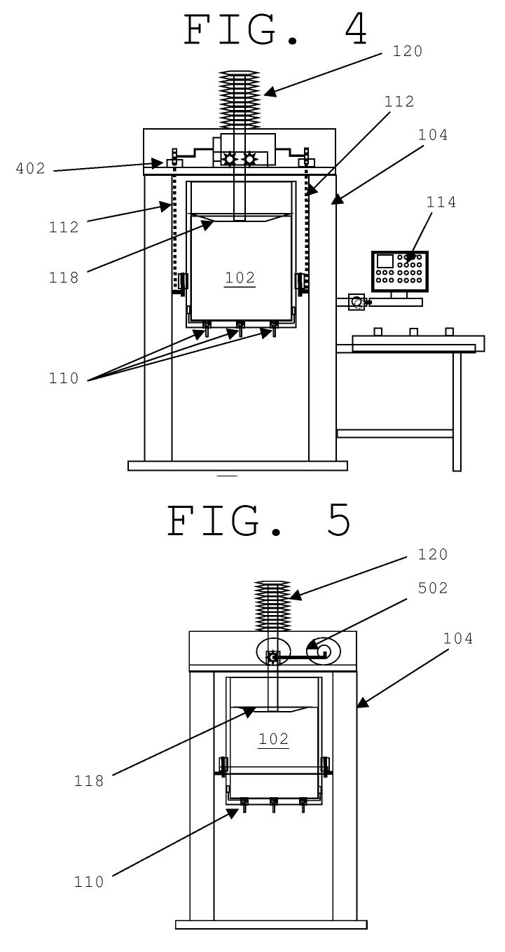

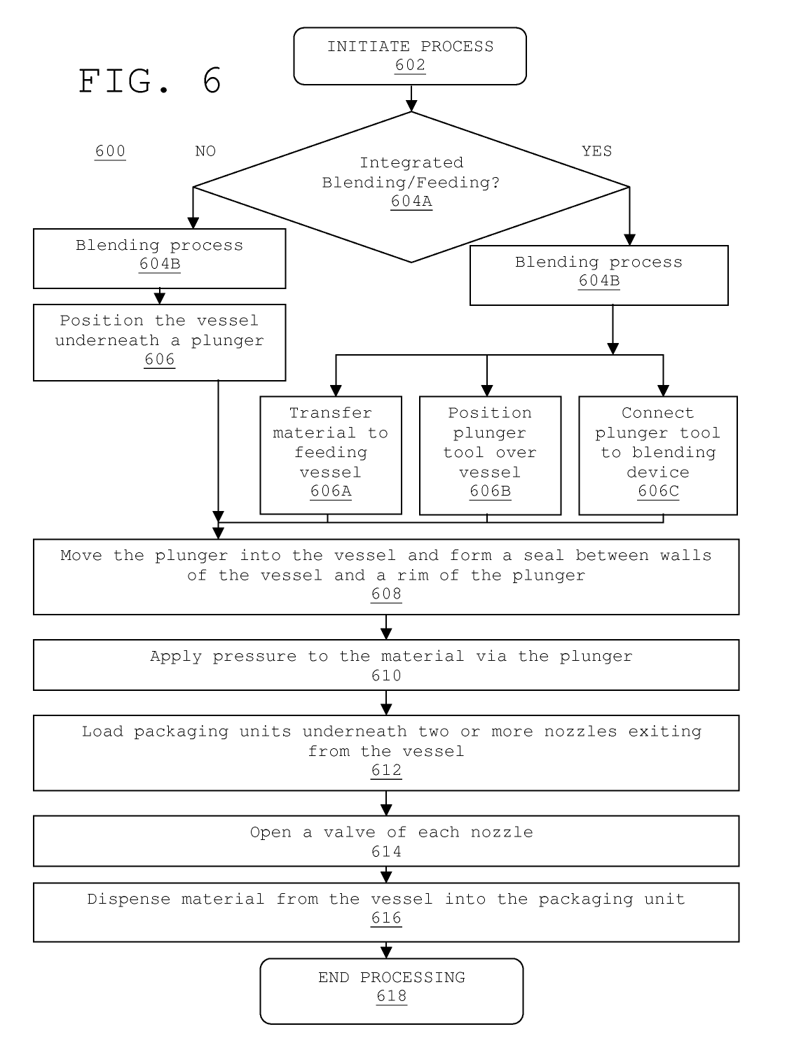

Referring to FIGS. 1 and 4, the system 100 may comprise a sealed top construction connecting four columns. A cylindrical vessel 102 can be moved into the dispensing, feeding and/or packaging unit 104 on a removable cart 106 or other transport device. The cylindrical vessel 102 includes a bottom construction 108 with a number of holes accommodating valves 110 in a grid design within the diameter of the cylindrical. The cylindrical vessel 102 may include enough space for housing the controlling parts, as well as evolution in vertical and horizontal pressures, based on the changing level of the column-height of the material.

A hoof-shaped positioning system 402, moving up- and downward on two servo motor driven spindles 112, elevates the cylindrical vessel 102 from the rolling cart 106 upward into the feeding position. This position may be secured by bolts. When the cylindrical vessel is secured in its feeding position, it may be connected to a PLC controller 114 through a quick-fit plug-in multiple pin connector and snap-lock air supply 116. This may allow use of multiple cylindrical vessels so that each cylindrical vessel may be connected to the controller 114 during dispensing and packaging.

The system 100 is not limited to a separate controller 114 that temporarily connects to the cylindrical vessel 102. In other embodiments, the controller 114 may be incorporated into the cylindrical vessel 102 with each cylindrical vessel 102 having a separate controller 114. This embodiment may include a connector that allows the controller 114 to gather data from sensors external to the cylindrical vessel 102.

A plunger 118 may be equipped with a peripheral polymer seal and a valve controlled air inlet/outlet in the center. When the plunger moves downward in its operating position the valve of the air inlet/outlet is opened and this device functions as the extractor of any air between the plunger and the material in the vessel. The material may be slightly pressurized by the plunger driven down in a precisely and continuously controlled via a plunger spindle 120. The plunger spindle 120 is driven by PLC controlled motor 502. Under minimal and constant pressure the material flows directly through the ball valve controlled nozzles into the packaging unit. The position of the ball valves at 3 mm under the bottom of the cylindrical vessel 102 may reduce or eliminate any material being pressurized and/or compressed in tubes/pipes. After passing the valve in each nozzle, the material flows into the packaging unit such as jars and cassettes without pressure and/or under reduced pressure to move a plunger downwards in a cartridge.

Referring to FIG. 2, a cross-section of the ball-valve embodiment 200 is shown. The holes 202 have a diameter 204 in relationship to the viscosity and the visco-elastic ratio, the grain size and the weight percentage of the non-organic pigments, fillers or metal particles. The inlet of the hole has a v-shaped design limiting the shear rate accelerations when the material is pressed into the outlet. The lowest point of the v-shape hole 202 is the level as the top of the radius of the ball-valve 206. Every individual hole is opened and closed by a load cell activating a compressed air driven lever 208 opening or closing the ball valve 206. The construction of the bottom 210 enables positioning of the closed ball valve with the top of its radius 3 mm under the top-line of the bottom of the cylindrical vessel. The system is not limited to 3 mm. This distance may be increased or decreased depending on the design of the system and intended application.

In the ball-valve embodiment 200, the system facilitates the filling of cartridges, caulking guns and similar types of packaging, featuring a plunger. When filling these packages through the snout, requiring the plunger of the cartridge to be moved by the inflowing material, a preset counter-pressure can be programmed. In this case the nozzle 212 is pressed into the snout of the packaging material. The snout is pressed against the flange 214 with a programmable preset force. The controller may automatically compensate for this preset pressure.

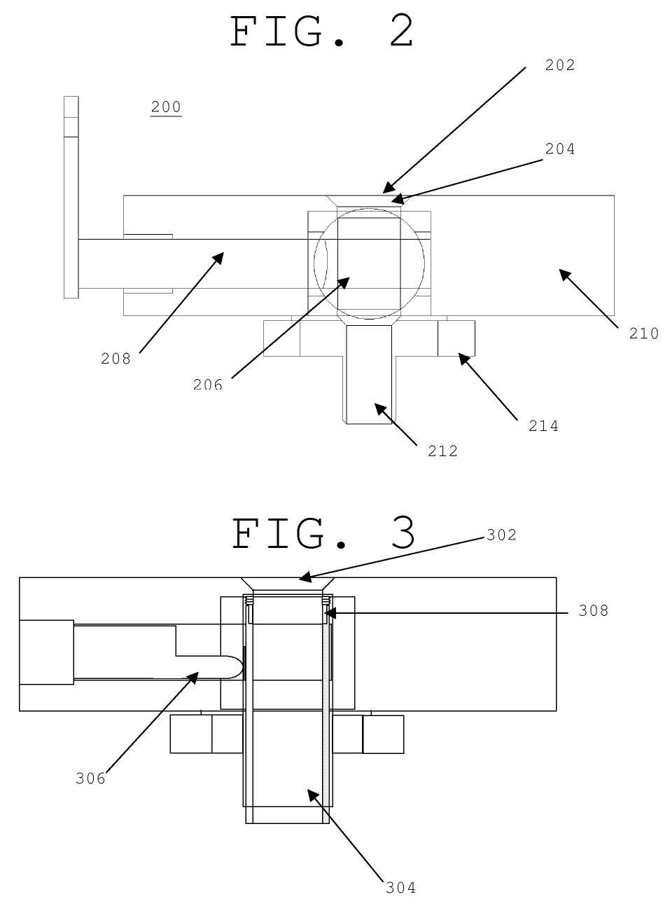

Referring to FIG. 3, a cross-section of the tube-valve embodiment 300 is shown, the holes 302 have a diameter in relationship to the viscosity and the visco-elastic ratio, the grain size and the weight percentage of the non-organic pigments, fillers or metal particles. The tube-valve may be a flexible silicon tube-valve. The tube-valve may enable replacement of the tubes 304 through loosening the flange 306 and mounting a new tube on a tube setting 308, at set intervals or between batches. The closing bolt with v-shaped, rounded head is driven by compressed air and controlled by the load-cells through the controller 114. This embodiment enables certification for sanitary fitness for pharmaceutical and food applications.

The valve construction may assure that the cylindrical vessel can be used for blending as well without the risk of building up single component of non-uniform conglomerates of the blend and the avoidance of stress in the material build up by the acceleration of shear-rates when material would pass the holes in the bottom. The mobile, quickly interchangeable mixing cylindrical vessel is entered into the dispensing, feeding and/or packaging station. The outlet design for feeding the material into the packaging units without any feeding tubes ands/or pipes allows for quick an thorough cleaning without loss of material or cross contamination between batches.

Packaging units may be inserted into an instantly interchangeable tooling device mounted on a slide-in table. Every packaging type may be situated over a load-cell. The load-cells are connected to a controller 114 that controls open/close position of the valves 110 in the bottom of the cylindrical vessel. The use of instantly interchangeable inserts positioned over the load-cells allows for changeover to different types of packaging without down-time of the feeding equipment.

When the cylindrical vessel is empty or packaging complete the valve on the air/inlet/outlet situated on top of the plunger 118 is opened and the plunger 118 can be moved upwards into its parking position. This construction eliminates the drawbacks of the present state of the art feeding systems as described hereinabove.

Referring to FIG. 6, an exemplary method for dispensing, feeding and/or packaging material according to the present invention 600. The dispensing, feeding and/or packaging process is initiated (block 602). Is the blending and feeding performed in the same vessel (block 604A)? If the blending is performed separately (“NO” Branch), the material is blended (block 604B) and then the vessel 102 is positioned underneath a plunger 118 (block 606). If the blending is integrated (“YES” Branch), the material is blended (block 604B) and different embodiments may incorporate addition steps as will be described with regard to embodiments later herein. The material may be transferred into the vessel 102 (block 606A), the material may be blended within the vessel 102 in which case the plunger 118 may then be positioned over the vessel 102 (block 606B) or the plunger 118 maybe connected to the blending tool (block 606C).

Once material is prepared (block 604) which may involve, for example, adding ingredients, blending, and/or altering the temperature. The plunger 118 is moved into the vessel 102 and forms a seal between walls of the vessel 102 and a rim of the plunger 118 (block 608). The plunger 118 may apply pressure to the material by being pressed against a top surface of the material (block 610). Packaging units may be loaded underneath two or more nozzles 110 exiting from the vessel 102 (block 612). The valves of each nozzle are opened as previous described with regard to the ball-valve and tube-valve embodiments (block 614). The material is dispensed from the vessel 102 into the packaging units (block 616). This may be accomplished by opening the valves 110 for a set period of time given a set pressure applied by the plunger 118. The system may also include weight sensors for each packaging unit. The controller may control the valves 110 based on current weight or may dispense material based on estimated time per shot. The system may use successive shots to load each packaging unit. A combination of weight measurements and estimated time per shot may be used to precisely load each packaging unit. The packaging units are removed and new packaging units may be loaded for the next dispensing cycle (block 618).

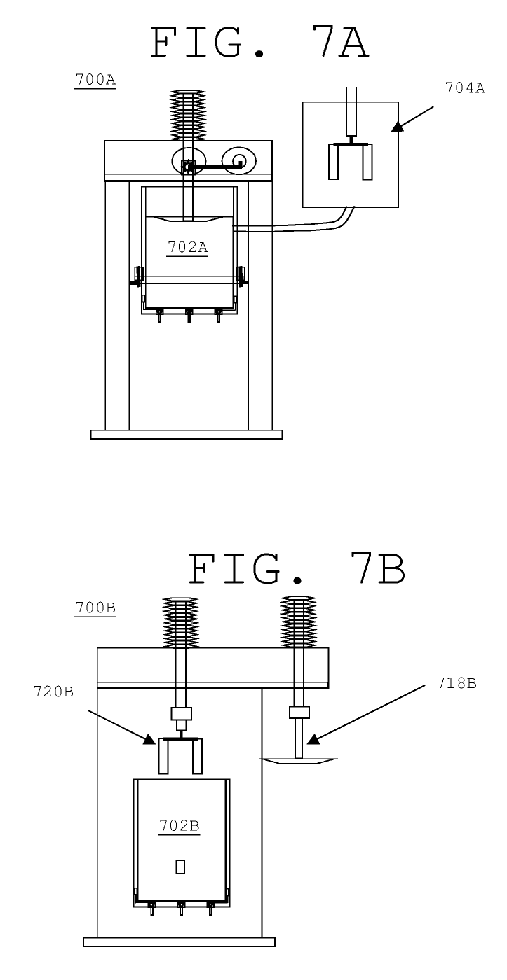

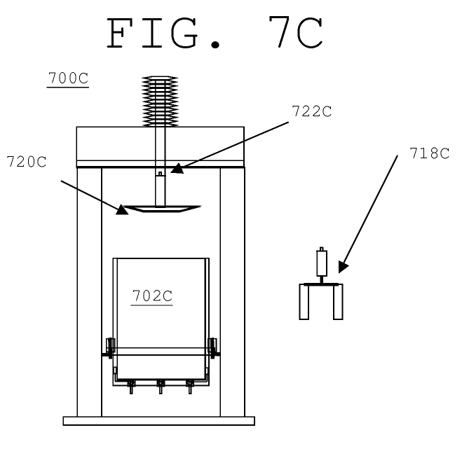

Referring to FIGS. 7A, 7B, and 7C, three different exemplary embodiment of the present invention are described. In the first embodiment 700A, a separate blending vessel 704A is used to prepare the material. The prepared material is supplied to the dispensing vessel 702A. This may be accomplished by dumping the material into the dispensing vessel 702A or feed the material through pipes/tubes.

In second embodiment 700B, the material is prepared and dispensed in the dispensing vessel 702B. Two tool heads are provided a plunger tool 718B and a blending tool 720B. The dispensing vessel 702B is positioned within the dispensing unit 704B. The blending tool 720B is inserted within the dispensing vessel 702B. Once the blending is complete the plunger tool 718B is moved into position and inserted into the dispensing vessel 702B.

In third embodiment 700C, the material is prepared dispensed in the dispensing vessel 702C. Two tool heads are provided a plunger tool 718C and a blending tool 720C. The dispensing vessel 702C is positioned within the dispensing unit 704C. The blending tool 720C is coupled to the tool head 722C and then inserted within the dispensing vessel 702C. Once the blending is complete the blending tool 720C is removed from the tool head 722C and the plunger tool 718C is coupled to the tool head 722C. The plunger tool 718C is then inserted into the dispensing vessel 702B.

In fourth embodiment (not shown), the material is prepared dispensed in the dispensing vessel 702C. A blending tool 720C is permanently mounted to the tool head 722C. Once the blending is complete, a plunger tool 718C is mounted to the bottom of the blending tool 720C and then inserted within the dispensing vessel 702C. The plunger tool 718C is then inserted into the dispensing vessel 702B. The invention is not limited to the above four exemplary preparing and dispensing embodiments.

Various changes coming within the spirit of the invention may suggest themselves to those skilled in the art; hence the invention is not limited to the specific embodiment shown or described but the same is intended to be merely exemplary. It should be understood that numerous other modifications and embodiments can be devised by those skilled in the art that will fall within the spirit and scope of the principle of the invention, which is not to be limited except by the following claims.

The invention claimed is:

1. A device for dispensing of material into a packaging unit comprising:
a movable vessel for holding the material prior to dispensing into packing unit, the movable vessel having walls and a bottom with two or more valves extend from the bottom wherein the valves open and close controlling a flow of material from the movable vessel into the packaging unit;
a plunger sized to fit within the movable vessel, provide a seal between a rim of the plunder and the walls of the movable vessel, and allow movement in a lateral motion to apply pressure to material within the movable vessel.

2. The device of claim 1, wherein each valve has a closed ball valve in a material outlet, with the top of a ball radius under a top-line of the bottom of the movable vessel.

3. The device of claim 1, further comprising: a packaging supply means for supplying packaging units to each valve.

4. The device of claim 1, further comprising
a lifting means for positioning the movable vessel underneath the plunger.

5. The device of claim 1, wherein the material is solder paste.

6. The device of claim 1, wherein the material has a specific gravity between about two to eight.

7. The device of claim 1, wherein the material has a dynamic viscosity between about fifteen and four hundred Pascal seconds.

8. A method for batch-wise preparing and dispensing of material into a packaging unit comprising the action of:
preparing the material in a vessel:
positioning the vessel underneath a plunger;
moving the plunger into the vessel and forming a seal between walls of the vessel and a rim of the plunger;
applying pressure to the material via the plunger;
loading packaging units underneath two or more nozzles exiting from the vessel;
opening a valve of each nozzle; and
dispensing material from the vessel into the packaging unit.

9. The method of claim 8, further comprising the action of:
supplying successive packaging units to each nozzle.

10. The method of claim 8, further comprising the action of;
weighing each packaging unit after an initial loading and
opening a valve of each nozzle for a set period of time based on each package weight.

11. The method of claim 8, further comprising the action of;
weighing each packaging unit after an initial loading and
opening a valve of each nozzle based on each respective package weight.

12. The method of claim 8, further comprising the action of:
coupling a pneumatic and electrical connector from a programmable logic control to the vessel.

13. The method of claim 8, wherein the material is solder paste.

14. The method of claim 8, prior to the action of positioning the vessel underneath a plunger further comprising the action of:
position a blending device within the vessel;
blending the material within the vessel; and
removing the blending device from within the vessel.

15. A system for batch-wise dispensing of solder paste into a packaging unit comprising:
a cylindrical vessel for holding the solder paste prior to dispensing into packing unit, the cylindrical vessel having walls and a bottom with two or more nozzles extend from the bottom wherein each nozzles has a valve to open and close controlling a flow of the solder paste from the cylindrical vessel into the packaging unit;
a dispensing unit having
a lifting device for receiving the cylindrical vessel and lifting the cylindrical vessel into a dispensing position and
a plunger sized to fit within the cylindrical vessel, provide a seal between a rim of the plunder and the walls of the cylindrical vessel, and allow movement in a lateral motion to apply pressure to paste within the movable vessel;
a package loading device for position packaging units underneath two or more nozzles exiting from the vessel; and
a controller for regulating the plunger and valves.

16. The system of claim 15, wherein each valve is a closed ball valve in a paste outlet, with the top of ball radius under a top-line of the bottom of the movable vessel.

17. The system of claim 15, wherein each valve is a closed flexible tube valve in a paste outlet, with a closed curvature of the valve under a top-line of the bottom of the movable vessel.

18. The system of claim 15, further comprising:
a controller for coordinating movement of the plunger and opening the valves.

19. The system of claim 15, further comprising:
a sensor for each loaded packaging unit for measuring the weight of each individual packaging unit during dispensing of solder paste.

20. The system of claim 19, further comprising:
a controller for coordinating movement of the plunger and opening the valves based on measurement of each sensor.
